(19) United States
(12) Patent Application Publication
(10) Pub. No.: US 2014/0004409 A1
(43) Pub. Date: Jan. 2, 2014

(54) SEALED BATTERY AND METHOD OF MANUFACTURING THE SAME

(71) Applicant: Kosuke NAKAMURA, Nisshin-shi (JP)

(72) Inventor: Kosuke NAKAMURA, Nisshin-shi (JP)

(73) Assignee: TOYOTA JIDOSHA KABUSHIKI KAISHA, Toyota-shi (JP)

(21) Appl. No.: 13/924,724

(22) Filed: Jun. 24, 2013

(30) Foreign Application Priority Data
Jun. 28, 2012 (JP) 2012-146156

(51) Int. Cl. H01M 2/08

(52) U.S. Cl. CPC H01M 2/08
USPC 429/179

(57) ABSTRACT

The invention relates to a sealed battery that is obtained by caulking a current collector terminal that is extended to an outside from inside an outer sheath to a metal terminal via an insulating body so that the current collector terminal and the metal terminal are fixed to the outer sheath. The insulating body has a wall portion that surrounds a periphery of the metal terminal. The height of the wall portion is greater than the height of a bottom portion of the insulating body, and equal to or smaller than the sum of the height of the bottom portion of the insulating body and the thickness of the metal terminal. The sum of the width of the wall portion and the height of the wall portion is equal to or greater than 1 mm.

### INCORPORATION BY REFERENCE

The disclosure of Japanese Patent Application No. 2012-146156 filed on Jun. 28, 2012 including the specification, drawings and abstract is incorporated herein by reference in its entirety.

### BACKGROUND OF THE INVENTION

1. Field of the Invention

The invention relates to a sealed battery and a method of manufacturing the same.

2. Description of Related Art

In Japanese Patent Application Publication No. 2008-192552 (JP-2008492552 A), there is disclosed an electrode structure in which part of a current collector terminal that is connected to an electrode body is caulked so that the current collector terminal is fixed to a metal terminal and a lid. An insulating body is arranged between the current collector terminal/the metal terminal and the lid to ensure insulation properties therebetween.

The insulating body in Japanese Patent Application Publication No. 2008-192552 (JP-2008-192552 A) has a wall portion that surrounds a lateral face of the metal terminal. Besides, the height of the wall portion is set higher than an upper face of the metal terminal, with a view to further ensuring the insulation properties between the metal terminal and the lid. However, since the wall portion of the insulating body is located higher than the metal terminal, the operations of caulking, cleaning and the like are troublesome.

### SUMMARY OF THE INVENTION

A first aspect of the invention relates to a sealed battery that is obtained by caulking a current collector terminal that is extended to an outside from inside an outer sheath to a metal terminal via an insulating body so that the current collector terminal and the metal terminal are fixed to the outer sheath. The insulating body has a wall portion that surrounds a periphery of the metal terminal. The height of the wall portion is greater than the height of a bottom portion of the insulating body and equal to or smaller than the sum of the height of the bottom portion of the insulating body and the thickness of the metal terminal, and the sum of the width of the wall portion and the height of the wall portion is equal to or greater than 1 mm.

In the sealed battery, a peripheral edge portion of a caulked region of the current collector terminal may be partially weld-bonded to the metal terminal.

A second aspect of the invention relates to a method of manufacturing a sealed battery that is equipped with an outer sheath, a current collector terminal that has a rivet that is extended to an outside through the outer sheath, a metal terminal that is connected to the current collector terminal by caulking the rivet of the current collector terminal, and an insulating body that is provided between the outer sheath and the metal terminal and has a wall portion that surrounds a periphery of the metal terminal. The insulating body is formed such that the height of the wall portion becomes greater than the height of a bottom portion of the insulating body and equal to or smaller than the sum of the height of the bottom portion of the insulating body and the thickness of the metal terminal, and that the sum of the width of the wall portion and the height of the wall portion becomes equal to or greater than 1 mm.

In the method, a caulking portion may be formed by caulking the rivet of the current collector terminal, and a peripheral edge portion of the caulking portion and the metal terminal may be partially weld-bonded to each other.

According to the invention, the operations of caulking, cleaning and the like are restrained from becoming troublesome, and the process of manufacturing can be simplified.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is a perspective view of a sealed battery;

FIG. 2 is a perspective view showing a lid assembly;

FIG. 3 is an end view of a terminal fetch portion, and is a view taken along arrows 3A-3A in FIG. 2;

FIGS. 4A, 4B, and 4C are views showing the caulking of a rivet, and are views taken along arrows 4B-4B in FIG. 2;

FIG. 5 is a view showing the welding of a caulking portion;

FIG. 6 is a view showing a dimensional relationship between a metal terminal and a wall portion of an insulating body;

FIG. 7 is a plan view showing a holding range of the metal terminal during caulking;

FIG. 8 is a view representing the movements of spatters during welding;

FIG. 9 is a view representing the movements of metal foreign matters during cleaning;

FIG. 10 is a view showing a dimensional relationship between the metal terminal and the wall portion of the insulating body; and

FIGS. 11A and 11B are views showing a dimensional relationship between the metal terminal and the wall portion of the insulating body.

### DETAILED DESCRIPTION OF EMBODIMENT

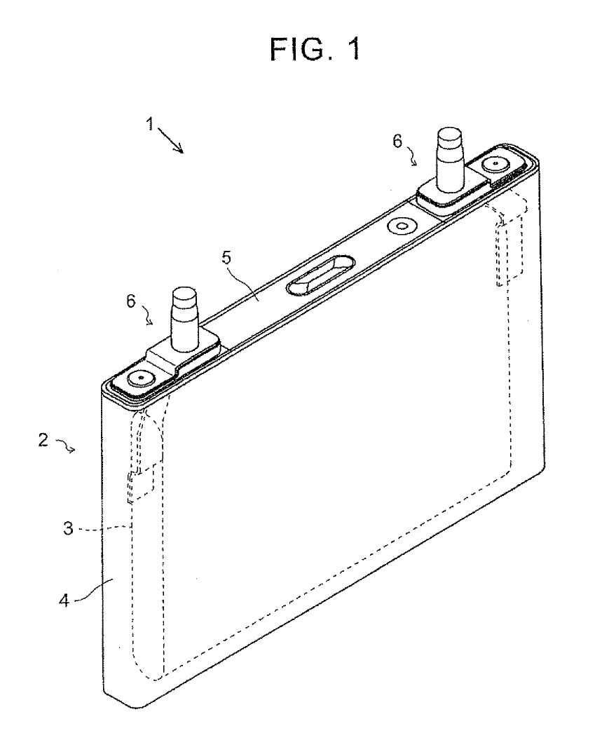

FIG. 1 shows the general configuration of a sealed battery 1. The sealed battery 1 is a repeatedly chargeable/dischargeable battery, for example, a rectangular lithium-ion secondary battery. The sealed battery 1 is equipped with an outer sheath 2, and an electrode body 3 that is accommodated inside the outer sheath 2. The outer sheath 2 is constituted of a container 4 that accommodates the electrode body 3, and a lid that closes up an opening of the container 4. The outer sheath 2 is sealed by bonding the container 4 and the lid 5 to each other. A positive electrode terminal 6 and a negative electrode terminal 6 that are connected to the electrode body 3 are fixed to the lid 5 in such a manner as to protrude outward, respectively.

The electrode body 3 is a winding material that is configured by laminating and winding a positive electrode current collector plate, a separator, and a negative electrode current collector plate. An electrode mixture of a positive electrode and an electrode mixture of a negative electrode are applied to the surface of the positive electrode current collector plate and the surface of the negative electrode current collector plate, respectively. In the lithium-ion secondary battery, a positive electrode active material including lithium ions, and a positive electrode mixture containing a conduction assistant and the like are applied to the positive electrode current collector plate, and a negative electrode mixture containing a negative electrode active material including a carbon-based material is applied to the negative electrode current collector plate. The electrode body 3 is caused to function as a charge/discharge element that can be repeatedly charged/discharged, by being impregnated with a non-aqueous electrolytic solution.

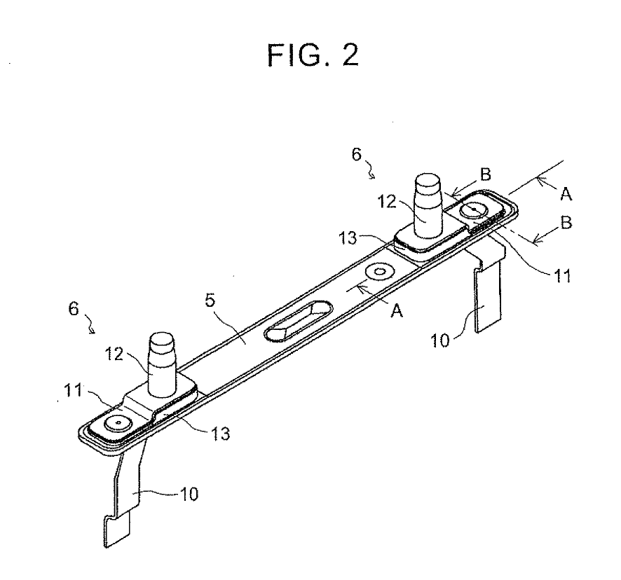

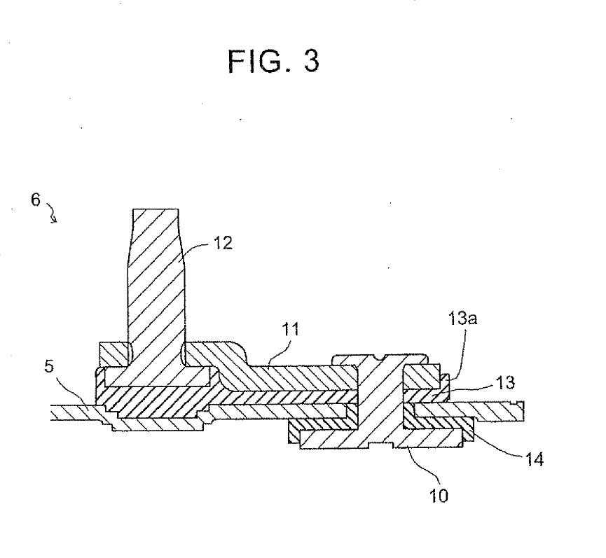

As shown in FIGS. 2 and 3, the terminals 6 are connected to the electrode body 3. Each of the terminals 6 includes a current collector terminal 10, a metal terminal 11, and an external terminal 12. Part of the current collector terminal 10 is extended to the outside through the lid 5. The metal terminal 11 is connected in such a manner as to abut on the current collector terminal 10. The external terminal 12 is provided in such a manner as to protrude outward from the metal terminal 11. An insulating body 13 and a gasket 14 are provided between each of the terminals 6 and the lid 5, so that the insulation properties therebetween and the air-tightness in a terminal fetch portion of the lid 5 are ensured. A lid assembly including these components is assembled by fixing the terminals 6 to the lid 5.

The current collector terminal 10 is bonded to the electrode body 3. The current collector terminal 10 is connected to the metal terminal 11, with part of the current collector terminal 10 fetched out of the lid 5. Besides, the insulating body 13 and the gasket 14 are provided between the current collector terminal 10 and the lid 5, so that the air-tightness of the outer sheath 2 is ensured, and the insulation properties between the current collector terminal 10 and the lid 5 are ensured. The metal terminal 11 is connected on one end side thereof to the current collector terminal 10, and on the other end side thereof to the external terminal 12. The metal terminal 11 is a flat plate terminal that is bent in the shape of Z in a lateral view. The insulating body 13 is arranged between the metal terminal 11 and the lid 5, so that the insulation properties between the metal terminal 11 and the lid 5 are ensured. The external terminal 12 is connected to the metal terminal 11. The external terminal 12 is provided in such a manner as to protrude outward from the metal terminal 11, and can be connected at a protruding portion thereof to an external instrument.

The insulating body 13 is arranged between the metal terminal 11 and the lid 5. In other words, the insulating body 13 is arranged on the lid 5, and the metal terminal 11 is laid thereon. A wall portion 13a that is extended along a lateral face of the metal terminal 11 is provided on a peripheral edge portion of the insulating body 13. That is, the insulating body 13 prevents the metal terminal 11 from being displaced while ensuring the creepage distance between the metal terminal 11 and the lid 5. The gasket 14 is arranged between the current collector terminal 10 and the lid 5. The gasket 14 is a sealing member for ensuring the insulation inside the battery and the air-tightness at an opening of the lid 5.

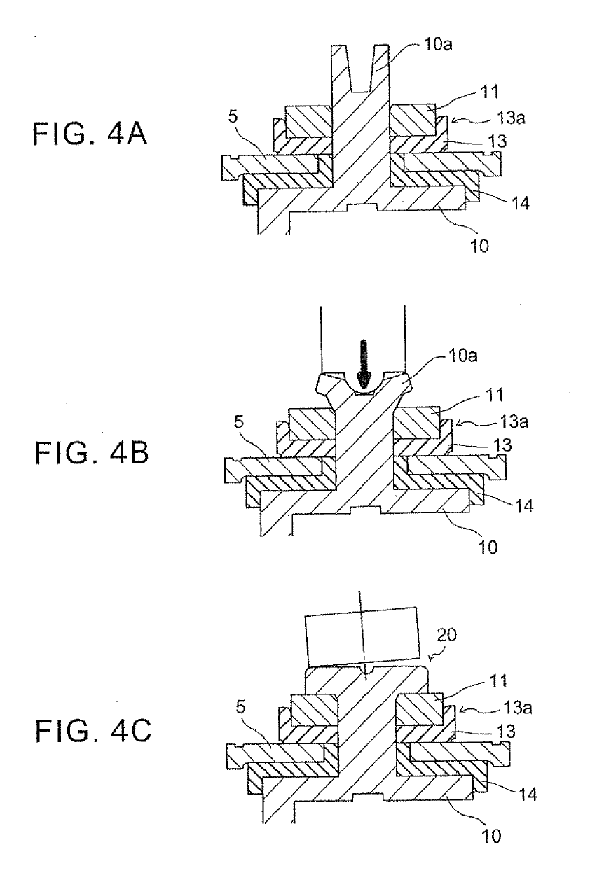

As shown in FIG. 4A, the current collector terminal 10 has a rivet 10a at a tip thereof. The rivet 10a is extended to the outside of the lid 5 through the gasket 14, the lid 5, the insulating body 13, and the metal terminal 11. As shown in FIG. 4B, the rivet 10a is press-caulked before being truly caulked. That is, the tip of the rivet 10a is widened and roughly processed. Then, as shown in FIG. 4C, an extended end of the rivet 10a is caulked through rotary caulking, and a caulking portion 20 is formed. Then, due to a compressive force applied to the caulking portion 20, the current collector terminal 10 and the metal terminal 11 are connected to each other while abutting on each other. Besides, the compressive force of the caulking portion 20 acts on the gasket 14 as a contact pressure, whereby the air-tightness at the terminal fetch portion of the lid 5 is ensured.

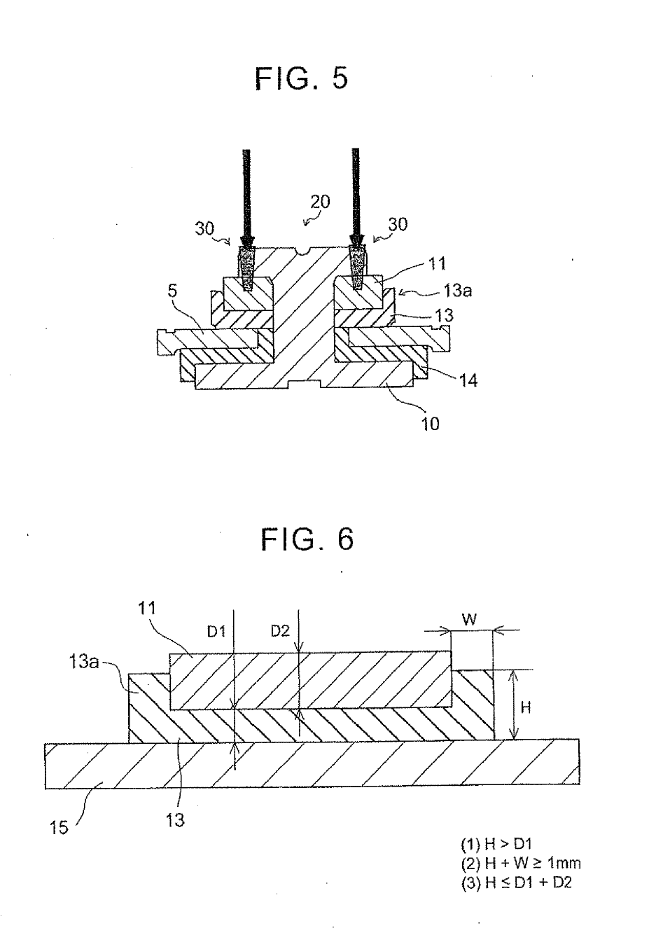

As shown in FIG. 5, a plurality of welding portions 30 are formed at a plurality of spots at an outer peripheral end of the caulking portion 20, through laser welding. By being weld-bonded to each other after being caulked, the current collector terminal 10 and the metal terminal 11 are reliably bonded to each other, so that the resistance of the caulking portion 20 decreases, and the conductivity between the current collector terminal 10 and the metal terminal 11 is ensured.

FIG. 6 shows a dimensional relationship between the wall portion 13a of the insulating body 13 and the metal terminal 11. The insulating body 13 is formed such that a height H of the wall portion 13a of the insulating body 13 becomes greater than a height D1 of a bottom portion of the insulating body 13 and smaller than the sum of the height D1 of the bottom portion of the insulating body and a thickness D2 of the metal terminal 11. Besides, a width W of the wall portion 13a is set such that the sum of the width W and the height H becomes equal to or greater than 1 mm. However, the height H of the wall portion 13a is defined as a height of a lateral face of the insulating body 13 around a region where the current collector terminal 10 is connected to the metal terminal 11 through caulking. The width W is defined as a size of the wall portion 13a in the lateral face direction in the region. Besides, the height D1 of the bottom portion of the insulating body 13 is a thickness of the insulating body 13 in a region where the metal terminal 11 is laid, The thickness D2 of the metal terminal 11 indicates a thickness of the metal terminal 11 in a region on the insulating body 13.

That is, the wall portion 13a is formed in such a manner as to fulfill all the following conditions (1) to (3), namely, the condition (1) that H>D1, the condition (2) that H+W≧1 mm, and the condition (3) that H≦D1+D2.

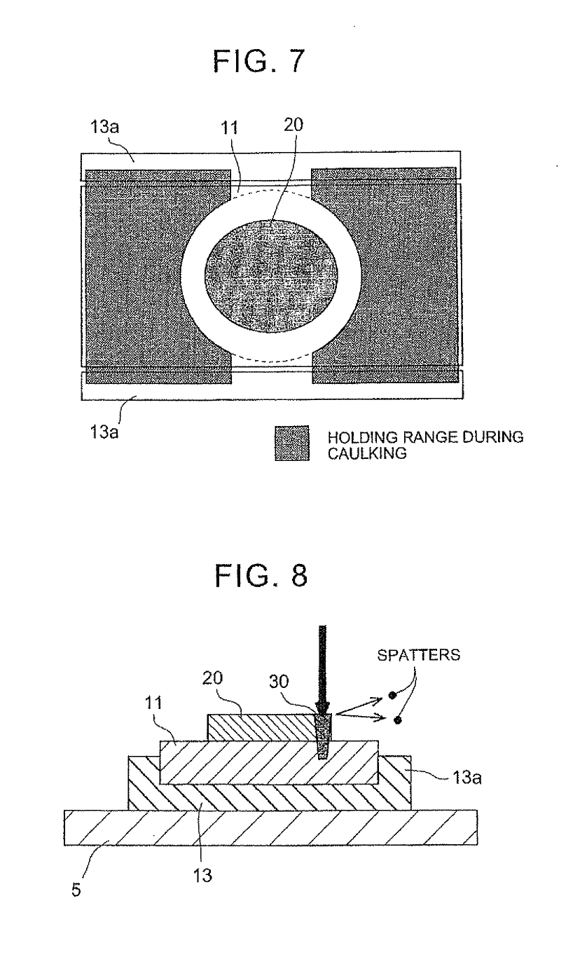

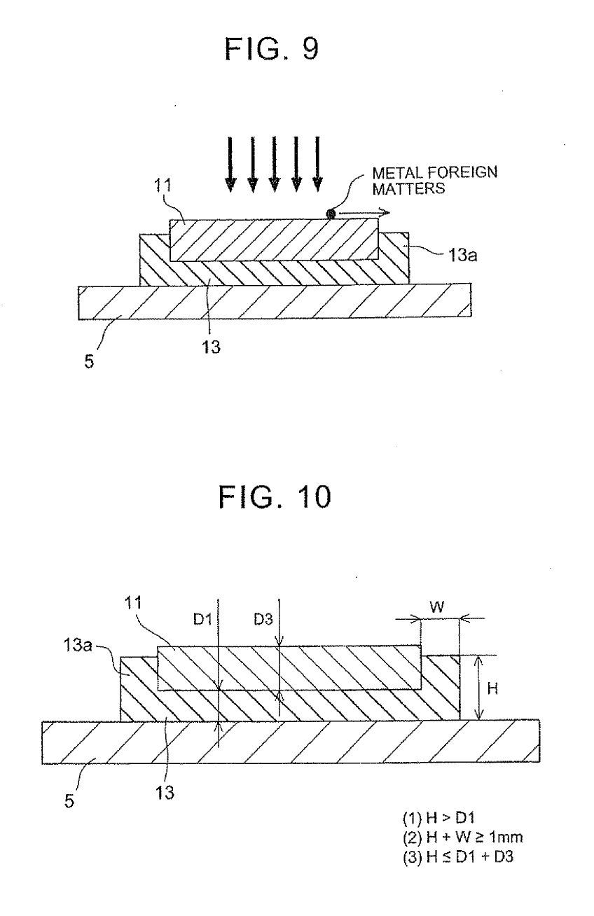

By forming the wall portion 13a on the foregoing conditions, the following effects are obtained. At least the wall portion 13a is located at a higher position than a tower face of the metal terminal 11. Thus, the periphery of the metal terminal 11 and the wall portion 13a can come into contact with each other, and the metal terminal 11 is reliably positioned by the wall portion 13a. The creepage distance between the metal terminal 11 and the lid 5 is ensured. Thus, the metal terminal 11 and the lid 5 are reliably insulated from each other. An upper face of the wall portion 13a is located at a lower position than an upper face of the metal terminal 11. Thus, the range where the metal terminal 11 is held during caulking can be extended onto the wall portion 13a, and the caulking portion 20 can be formed with a vast holding area ensured, and can be restrained from being deformed (see FIG. 7). Since the insulating body 13 does not exist beside a welding portion 30 in laser-welding the peripheral edge portion of the caulking portion 20, burnt deposits can be restrained from being formed by spatters (see FIG. 8). When the metal terminal 11 is cleaned by shower after being welded, metal foreign matters remaining on the metal terminal 11 can be extruded sideways and reliably removed (see FIG. 9). By setting the wall portion 13a of the insulating body 13 as described above, the processes of caulking, cleaning and the like in manufacturing the sealed battery 1 are restrained from becoming troublesome, and the process of manufacturing can be simplified.

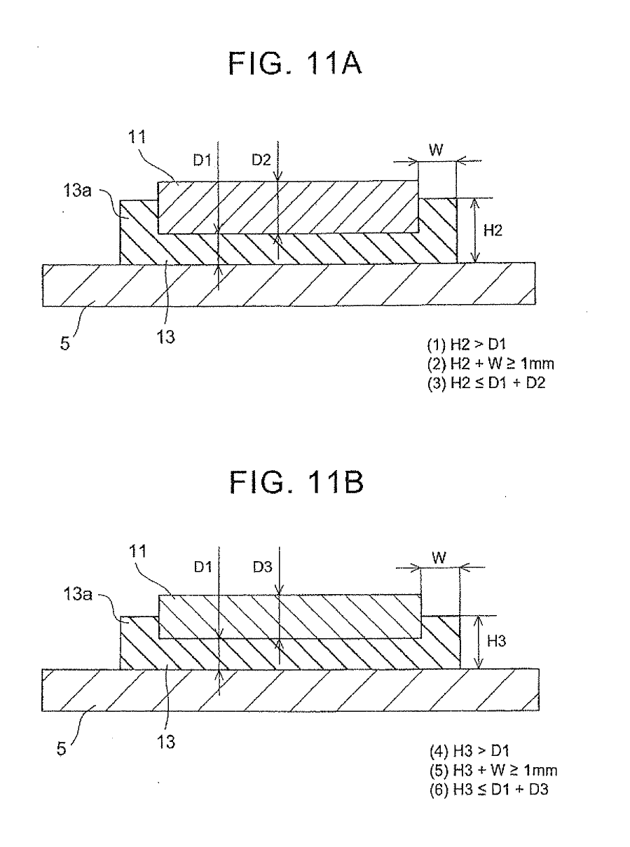

Besides, FIG. 10 and FIGS. 11A and 11B show how to handle a dimensional relationship in the case where the thickness of the metal terminal 11 at the positive electrode and the thickness of the metal terminal 11 at the negative electrode are different from each other. FIG. 10 shows an example in the case where the common insulating body 13 is used. FIGS. 11A and 11B show examples in the case where the insulating body 13 with different conditions on the wall portion 13a is used.

In the case shown in FIG. 10, the dimension of the wall portion 13a is set as follows using a thickness D3 (D2>D3) of the metal terminal 11 on a small thickness side, namely, such that (1) H>D1, (2) H+W≧1 mm, and (3) H≦D1+D3 (N.B. D2>D3).

In the case shown in each of FIGS. 11A and 11B, the dimension of the wall portion 13a (the heights are defined as H2 and H3 respectively) is set as follows in accordance with each thickness D2 or D3 of the metal terminal 11, namely, such that (1) H2>D1, (2) H2+W≧1 mm, and (3) H2≦D1+D2, or such that (4) H3>D1, (5) H3+W≧1 mm, and (6) H3≦D1+D3.

What is claimed is:

1. A sealed battery comprising:
an outer sheath;
a current collector terminal extended to an outside from inside the outer sheath;
an insulating body arranged outside the outer sheath; and
a metal terminal arranged on the insulating body, wherein
the current collector terminal and the metal terminal are fixed to the outer sheath via the insulating body with the current collector terminal caulked to the metal terminal, and
the insulating body has a wall portion that surrounds a periphery of the metal terminal, a height of the wall portion being greater than a height of a bottom portion of the insulating body and equal to or smaller than a sum of the height of the bottom portion of the insulating body and a thickness of the metal terminal, and a sum of a width of the wall portion and the height of the wall portion being equal to or greater than 1 mm.

2. The sealed battery according to claim 1, wherein a peripheral edge portion of a caulked region of the current collector terminal is partially weld-bonded to the metal terminal.

3. A method of manufacturing a sealed battery that is equipped with an outer sheath, a current collector terminal that has a rivet that is extended to an outside through the outer sheath, a metal terminal that is connected to the current collector terminal by caulking the rivet of the current collector terminal, and an insulating body that is provided between the outer sheath and the metal terminal and has a wall portion that surrounds a periphery of the metal terminal, the method comprising:
forming the insulating body such that a height of the wall portion becomes greater than a height of a bottom portion of the insulating body and equal to or smaller than a sum of the height of the bottom portion of the insulating body and a thickness of the metal terminal, and that a sum of a width of the wall portion and the height of the wall portion becomes equal to or greater than 1 mm.

4. The method according to claim 3, further comprising:
forming a caulking portion by caulking the rivet of the current collector terminal, and partially weld-bonding a peripheral edge portion of the caulking portion and the metal terminal to each other.
